(19) United States
(12) Patent Application Publication
(10) Pub. No.: US 2004/0023734 A1
(43) Pub. Date: Feb. 5, 2004

(54) Real-time worldwide wireless golf competition network

(76) Inventor: Scott Andrew McClain, Norristown, PA (US)

Correspondence Address: SCOTT ANDREW McCLAIN, 1720 LOCUST STREET, NORRISTOWN, PA, 19401, US

(21) Appl. No.: 10/411,160

(22) Filed: Apr. 10, 2003

Related U.S. Application Data
(60) Provisional application No. 60/371,625, filed on Apr. 11, 2002.

(51) Int. Cl. A63B 57/00; G06F 17/00

(52) U.S. Cl. 473/409; 463/7

(57) ABSTRACT

A method and a system for a real-time, worldwide, wireless, golf competition Network in which a plurality of remotely located players, of varying abilities, compete in real-time on an equitable basis while participating in head-to-head matches, and/or in a running tournament, in real-time, while playing actual/physical rounds of golf, in real-time, on separate golf courses, and while communicating in real-time through wireless devices connected to a central Network which manages the matches and/or the running tournament. One method of adjusting scores for the invention uses the USGA Handicap Index, Slope Rating system and Course Rating system to equitably compare the scores of rounds, which will include other Network members' rounds, live PGA/LPGA/SENIOR professionals' rounds, and archived PGA/LPGA/SENIOR professionals' rounds. Methods are also provided for tracking a variety of performance metrics of Network golfers, gathering demographical information of Network golfers, managing wagers between Network golfers and managing communications between Network golfers.

### CROSS REFERENCE TO RELATED APPLICATIONS

This application claims the benefit under Title 35, U.S.C. Sec. 119(e) of U.S. Provisional Patent Applications assigned Disclosure Document Application Number 502838, filed Jan. 7, 2002, entitled REALTIME, WORLDWIDE, DIGITAL GOLF NETWORK, and assigned Provisional Patent Application No. 60/371,625, filed Apr. 11, 2002, entitled REAL-TIME, WIRELESS, DIGITAL GOLF NETWORK, respectively.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

The present invention relates to a method and system for creating a real-time, worldwide, wireless, golf competition Network in which a plurality of remotely located players, of varying abilities, compete in real-time on an equitable basis while participating in head-to-head matches, and/or in a running tournament, in real-time, while playing actual/physical rounds of golf, in real-time, on separate golf courses, and while communicating in real-time through wireless devices connected to a central Network which manages the matches and/or the running tournament.

### BACKGROUND OF THE INVENTION

Competitive golf matches are a popular form of recreation. Regardless of the level of individual play, the concept of a golf handicap has enabled golfers of all skill levels to compete on an adjusted, equitable basis due to the STANDARDIZED structure of the system.

Likewise, the creation and implementation of Course Ratings and Slope Ratings have further STANDARDIZED the adjusted, equitable, competitive format, increasing the ability for golfers of all skill levels to have a more accurate stroke-spotting comparison based on an individual golfer's skill level comparative to the difficulty of any specific golf course.

The combination of these aforementioned methods makes a round of golf highly competitive, whether there are two or more players involved, because of the augmented equitable basis. Many golfers have a desire to enjoy legitimate competition, as well as wager money (or gentlemen's bets) during the course of play, and the standardized structure of implementing these aforementioned methods provides a level playing field for doing so.

However, many golfers historically have considered it unrealistic to be able to compete equitably with friends, co-workers or other golfers, who by the constraints of distant geographical location cannot be on the same physical golf course at the same time. It has historically been assumed by most golfers that two or more golfers are required to be playing on the same physical golf course at the same time, or during the same day, in order to equitably compare performance levels. The present invention discounts this assumption as no longer valid.

By following the directives of the USGA regarding the stroke allowances or stroke-spotting for a “same course, different tees” scenario, as well as drawing from prior golf experience, it can logically be determined that two golfers playing on the same course, at the same time, or during the same day, but from differing sets of tee boxes are technically playing on separate golf courses. This is due to the nature of hole distances, tee box placements, etc. One example of this conclusion would be that certain hazards come into play from the “blue” tees that are not present from the “white” tees (i.e. a par 3 tee shot from the “blue” tees involves a carry over water to the green, whereas a tee shot from the “white” tees on the same hole has a clear approach over land to the same green).

Because this holds true for differing sets of tee boxes on a single golf course, the same concept can be further extrapolated to separate golf courses. This enables the present invention to include all tee-boxes on all golf courses, worldwide, and consider each, individual set of tee-boxes on such golf courses worldwide to be distinct and separate golf courses in and of themselves.

Occasionally, golf courses hold or host handicap-based tournaments, which allow golfers of all skill levels the chance to be awarded prizes, regardless of total stroke counts, because of the adjusted stroke allowance built-in by the handicapping concept.

However, most golfers do not enter into public tournaments for several reasons, both personal and logistical, but nonetheless desire a true sense of, and venue for, competition. Many times the golfer(s) involved in a particular round may desire an increased sense of competition. Playing a round with friends or business clients, as is common, may not provide a desired venue for highly competitive play. At times golfers may even be playing a particular round alone, albeit linked up with others, and regardless of skill level, they may desire a familiar or comfortable venue for competition, aside from the stranger(s) they become linked up with for the present round.

Taking all of the aforementioned into consideration, the present invention utilizes a proprietary method and system to create a real-time, worldwide, wireless, golf competition Network, which incorporates the USGA Handicapping System, Course Rating System and the Slope System, and creates a new level of standardization by which a plurality of golfers, on separate golf courses, can now compete in real time via wireless technologies, and still experience a heightened sense of tournament style competition wherever and whenever a member of the Network plays an actual round of golf.

“Thanks to the USGA Handicapping System, all golfers can compete on an equal basis. The USGA Course Rating System ensures that golf courses are rated in relation to all other courses. The USGA Slope System adjusts a player's USGA Handicap Index according to the difficulty of a course. As a result, no matter who golfers play with—or where they play—they can enjoy a fair game.” —USGA

Both video sport games and Internet based sport games allow for individuals to compete in a limited fashion, however, the individual is confined to a “virtual” environment that does not adequately simulate the real world or real world experiences. This type of gaming also does not allow for the individual to physically carry out the requirements involved with the corresponding sport. In the sport of golf, although video games, Internet games and stand-alone simulators may seem somewhat realistic due to highly advanced graphical technologies, the individual is not physically playing an actual round of golf on a real golf course, under typical environmental playing conditions associated with the sport, and therefore the scores established through this type of exercise cannot be considered actual golf scores.

In U.S. Pat. No. 5,779,549 (Walker et al.), a database-driven online distributed tournament system is described, detailing “A method and a system for a distributed electronic tournament system in which many remotely located players participate in a tournament through input/output devices connected to a central controller which manages the tournament.” However, the suggested involvement by participating individuals is taking place through associated input/output devices—this being the method of involvement for video games and Internet based games—and not by playing an actual round of golf on a real golf course. Also, in U.S. Pat. No. 5,779,549 (Walker et al.), the suggested system described is not particular to the sport of golf, as several other competitive activities are referenced.

In U.S. Pat. No. 6,321,128 (Costin IV et al.), a virtual golf game is described, detailing “A system and method adequately and accurately compares golf scores from two different courses by comparing the relative difficulty of each course played and the relative ability of the players in conjunction with a selected Tournament course, which may be an imaginary or physical course, for determining the winner of a match or game of golf.” While this system appears to be considering a similar solution to the competition of golfers on separate golf courses, it is unnecessary to involve an additional, separate Tournament course for adequate and equitable comparisons. Furthermore, by making one possibility of the suggested Tournament course be an imaginary course, the reliable adherence to generally accepted golfing standards set forth by the USGA for rating golf courses is discarded; imaginary courses cannot be accurately and equitably rated with real golf courses, nor can they be physically played upon.

In addition, U.S. Pat. No. 6,321,128 (Costin IV et al.) further states “after each player has played a game of golf, the scores are arranged by hole length for each given course; after which the scores are transferred to the Tournament course which has also been arranged by hole length, shortest to longest.” The suggested method involved for the posting of scores does not take place in real-time, nor is data communicated in real-time via wireless device through a real-time wireless Network; instead the posting of scores takes place “after each player has played a game of golf”.

Golfers who are desirous of realistic competition, wherein scores from separate golf courses are compared on an equitable basis, will not want to wait until they have completed their actual round of golf, and be required to input a totality of scores for such completed rounds.

The present invention details a method and system for a real-time, worldwide, wireless, golf competition Network, wherein the posting of scores takes place in actual real-time, hole-by-hole, as golfers participate in their separate rounds of golf, and communicate with the Network in real-time via wireless devices.

### BRIEF SUMMARY OF THE INVENTION

An object of the present invention is to provide a method and system for creating a real-time, worldwide, wireless, golf competition Network in which a plurality of remotely located players, of varying abilities, compete in real-time on an equitable basis while participating in head-to-head matches, and/or in a running tournament, in real-time, while playing actual/physical rounds of golf, in real-time, on separate golf courses, and while communicating in real-time through wireless devices connected to a central Network which manages the matches and/or the running tournament. The options of competition may include head-to-head matches and/or tournament play, where Network members are competing against each other's rounds, and/or live PGA/LPGA/SENIOR Tour rounds, and/or archived PGA/LPGA/SENIOR Tour rounds, in real-time, over the “Network”, wherever and whenever Network members play an actual/physical round of golf.

In the invented system, players pay entry fees for access to the system or Network in order to compete in matches and/or the tournaments, and to track the accrual of personal golf statistics from each of the entered rounds.

Due to the complexity of coordinating a plurality of players, golf courses, tee-boxes and matches, in one preferred embodiment, a central database manages the golf matches, coordinating both stored player information and stored golf course information. This central database may be linked in conjunction with a Web-based Network for cost-effective distribution. The system, or Network, uniquely identifies each player as they log-in, via a wireless device, or otherwise, authenticating the paid status for access to the system or Network. This unique identifier also allows individual players to know whom they are competing against, what golf course the competitor is playing on, the competitor's golf course data regarding Course Rating, Slope Rating and Course Handicap for the established tee boxes being played, and the comparative stroke-spotting for the present match. The Network will be able to manage each golf match in real-time, hole-by-hole, receiving and transmitting data to Network members who are communicating with the Network via wireless devices.

After each match is over, the system evaluates player performance, calculates win-loss-tie categories, and transmits the results to Network members. The Network will continuously store data for each unique player, and an internal Network Handicap Index for each member will be continually tabulated and used for Network-specific recreational events and related purposes, solely within the Network. (This Network Handicap Index is not officially sanctioned by either the USGA or the Royal and Ancient Golf Club of St. Andrews, and will not be considered substitutable as, corresponding with, working in tandem with, working in conjunction with, replacements of, or replacements for an individual golfer's official USGA Handicap Index, unless otherwise noted. Official USGA Handicap Indexing should be handled only through the membership of an official USGA Golf Club or USGA Golf Association). Other golf-related performance metrics will also be subject to collection, as desired by each individual Network member: i.e. fairways in regulation, greens in regulation, putts per hole, eagles, birdies, pars, bogeys, double-bogeys, holes-in-one, etc. This data tracking can be used for additional on-going “Virtual Tournament” categories, as well as for personal enrichment.

In an additional potential tournament-based embodiment, Network members may also pay additional fees in order to have their accrued scores entered into an on-going “Virtual Tournament” so as to compete for substantial prizes and awards. Each eligible match in the “Virtual Tournament” is tracked over the entire Network for a pre-determined time period, and the number of overall participants in the said “Virtual Tournament” is then broken down into a qualifying average, which eliminates a certain number of participants from each intended category. In order to further enhance this experience, professional golf tournament language will be used, informing those who qualify that they have “made the cut”. The “Virtual Tournament” then continues in a series of assigned, additional matches, in bracket fashion, in which players must continue to “make the cut” or qualify in order to advance to additional rounds of tournament play. This “Pro Tour style” elimination format significantly increases tension and enhances excitement in the overall “Virtual Tournament ”, since only the best players are left competing for the top prizes in the final tournament rounds.

In another additional potential embodiment, each Network member will be able to establish an account within his/her member profile that will be used for wagering funds based upon round performance(s). The Network uniquely identifies each player as they log on via a wireless device, authenticating the “Network member's” paid status for access to the system, as well available funds for wagering. This unique identifier also allows individual players to know whom they are competing against, and allow for the establishment of wagering terms for the corresponding match. Upon acceptance of wagering terms, each player will be notified of the wagering terms, as well as established, comparative stroke-spotting for the match, and upon completion of the match, players will be notified of the transfer of appropriate funds to the relative accounts.

Included in the Player Profile section of the Network, the member can establish a Favorites list. This list might include the names of friends, family members, or co-workers, regardless of geographical location. This feature is very desirable for those members who have friends, family members, or co-workers that used to be in his/her geographical area, but now have moved away. By utilizing the Favorites feature, members can still experience the thrill and excitement of competition with their “regular foursome”, even though the group is now geographically displaced. Expanded elements of this feature will also prove useful for corporations, charities, clubs, etc. who might want to organize and distribute their own private, mini-tournaments through the Network.

### BRIEF DESCRIPTION OF THE DRAWINGS

FIG. 1 is a flowchart detailing the data pathway for match OPTION #1 & match OPTION #2 OPTION #1: HEAD-to-HEAD play vs. other Network member(s) in Favorites list. OPTION #2: HEAD-to-HEAD play vs. other Network member as an open challenge.

FIG. 2 is a flowchart detailing the data pathway for match OPTION #3 OPTION #3: HEAD-to-HEAD play vs. PGA/LPGA/SENIOR Pro's on current professional Tour schedule.

FIG. 3 is a flowchart detailing the data pathway for match OPTION #4 OPTION #4: HEAD-to-HEAD play vs. PGA/LPGA/SENIOR round from “classic round” archives.

FIG. 4 is a graphical-user-interface template for the Network log-in screen.

FIG. 5 is a graphical-user-interface template for the Network personal profile introductory screen.

FIG. 6 is a graphical-user-interface template for the Network personal profile bio info screen.

FIG. 7 is a graphical-user-interface template for the Network personal profile billing info screen.

FIG. 8 is a graphical-user-interface template for the Network personal profile welcome screen.

FIG. 9 is a graphical-user-interface template for the Network match selector screen.

FIG. 10 is a graphical-user-interface template for the Network course selector screen.

FIG. 11 is a graphical-user-interface template for the Network tee-box selector screen.

FIG. 12 is a graphical-user-interface template for the Network hole-by-hole leader board and input screen.

FIG. 13 is a table illustrating an example of the stroke-spotting formula detailing that player A spots player B strokes.

FIG. 14 is a table illustrating an example of the stroke-spotting formula detailing that player B spots player A strokes.

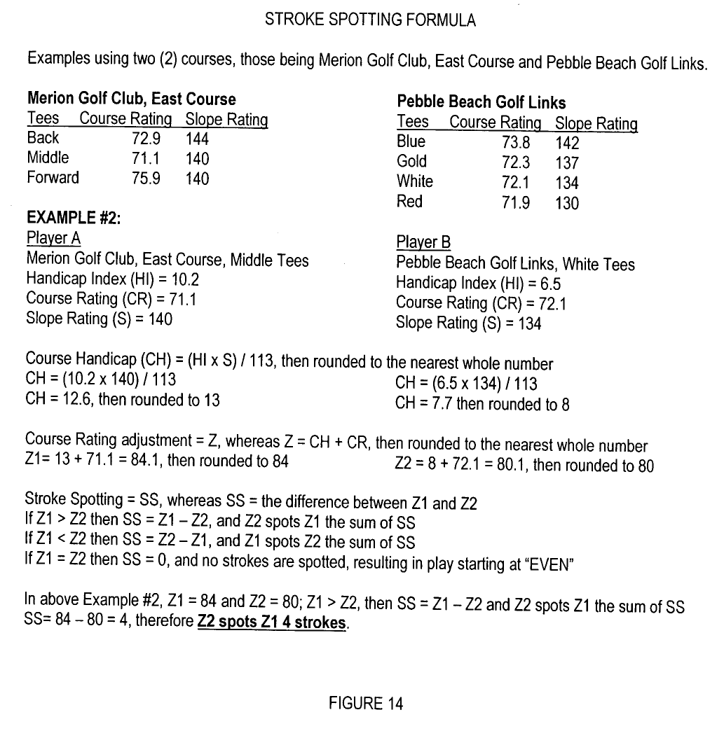

FIG. 15 is a table illustrating an example of the stroke-spotting formula detailing that no strokes are spotted.

FIG. 16 is a table illustrating an example of a formula detailing the calculations for determining the running tallies and real-time postings of “leader board” style outputs.

### DETAILED DESCRIPTION OF THE INVENTION

The real-time, worldwide, wireless, golf competition Network will be designed and authored in such a way as to be universally accepted, regardless of PDA or other wireless device, or perhaps Internet browser.

One preferred embodiment is to utilize a database-driven, Web-based Internet portal, in order to “gain access to” and “distribute information from” the Network. In this manner, Network members will be able to maintain their own wireless/web service provider account, regardless of their geographical locale, and can utilize their own wireless device to access the Network at anytime, anywhere.

The Network will consist of subscribing members who pay dues to access the products and services.

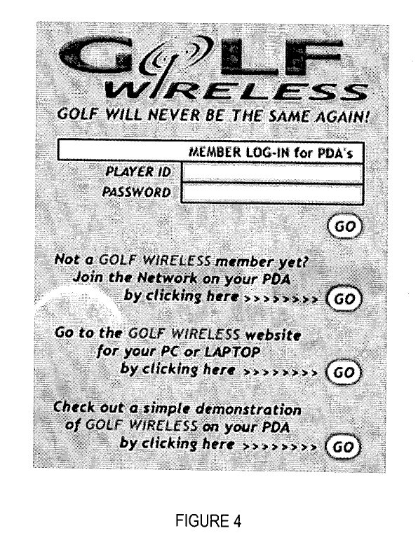

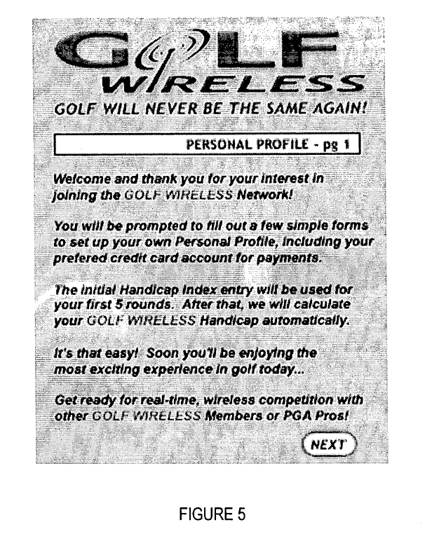

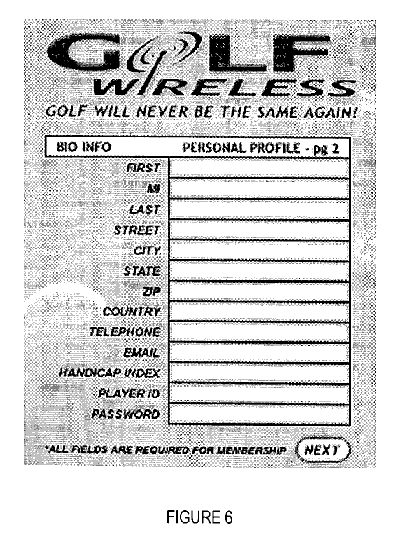

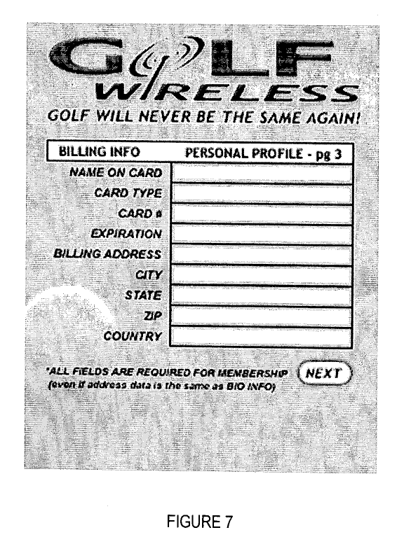

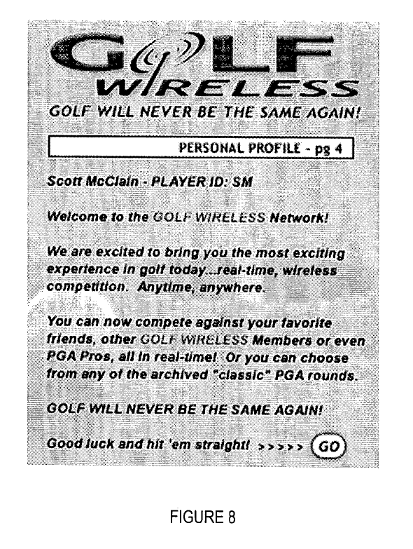

Existing Network members will be able to log-in to the Network (see FIG. 4). Non-Network member golfers, desirous of participating, will be able to create a player profile within the Network to become a member (see FIG. 5 thru FIG. 8). This profile will contain both player-specific biographical information (see FIG. 6) as well as player-specific billing information (see FIG. 7), and will have an alphanumeric unique-identifier tag assigned to the player's information, for future log-in purposes to the Network. The database containing all pertinent Network member information will be securely treated for the highest possible privacy protection of the Network members.

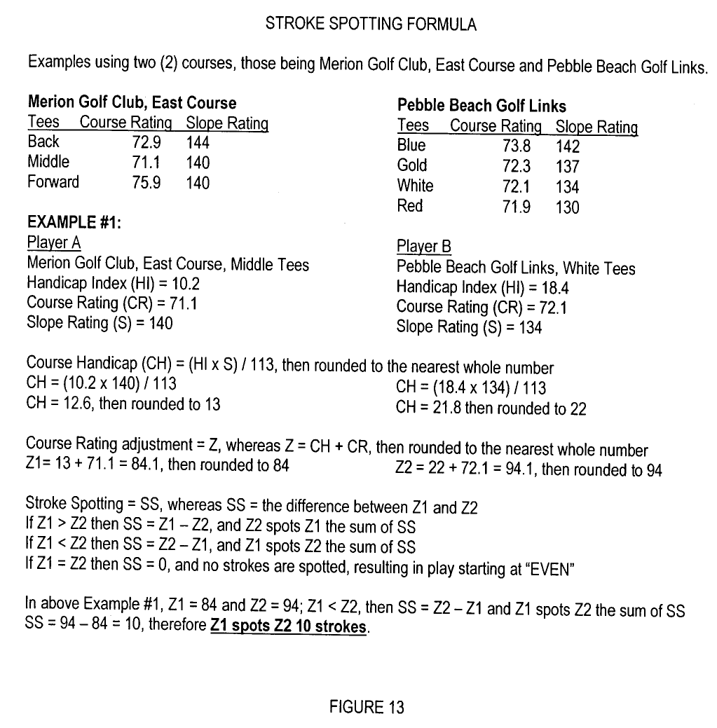

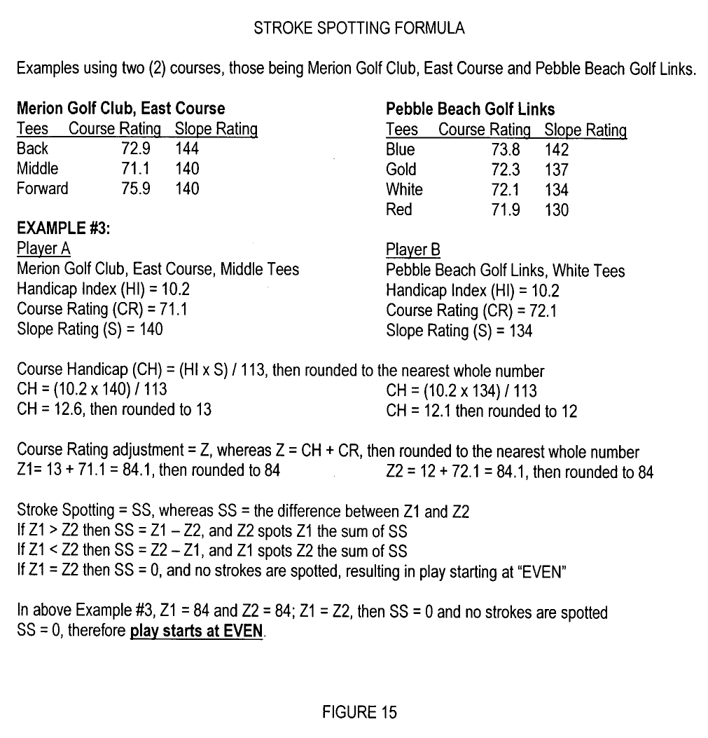

Each new member will be able to use their existing USGA Handicap Index initially (if they have one), but as rounds are logged through the Network, an internal Network Handicap Index for each member will be continuously tabulated and used for Network-specific recreational events and related purposes, solely within the Network. (This Network Handicap Index is not officially sanctioned by either the USGA or the Royal and Ancient Golf Club of St. Andrews, and will not be considered substitutable as, corresponding with, working in tandem with, working in conjunction with, replacements of, or replacements for an individual golfer's official USGA Handicap Index, unless otherwise noted. Official USGA Handicap Indexing should be handled only through the membership of an official USGA Golf Club or USGA Golf Association). As members participate in matches, this information will be used for the spotting of strokes. The spotting of strokes for each match will be calculated based upon each member's differing Handicap Indexes and the respective Course Ratings and Slope Ratings for the associated tee boxes on the courses of play (see FIG. 13 thru FIG. 15 for examples of calculations).

Included in the player profile section, the member will be able to establish a favorites list. This list might include the names of friends, family members, or co-workers, regardless of geographical location. In fact, this feature is very desirable for those members who have friends, family members, or co-workers that used to be in his/her geographical area, but now have moved away. By utilizing the favorites feature, members can pre-arrange matches, in a sort of “virtual outing”. This way, golfers can still experience the thrill and excitement of competition with their “regular foursome”, even though the group is geographically displaced. Expanded elements of this feature will also prove useful for corporations, charities, clubs, etc. who might want to organize and distribute their own private, mini-tournaments through the Network.

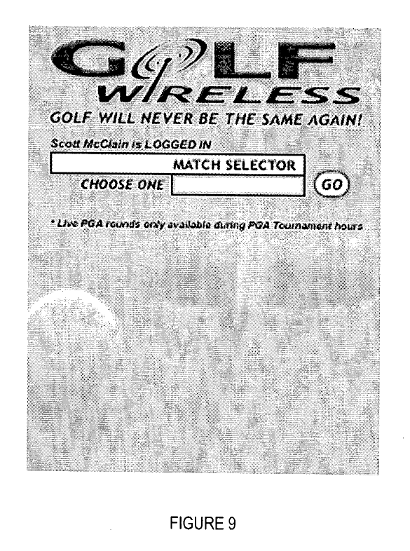

Once the member has established a player profile, whenever the member decides to play a round of golf on the course of his/her choice, the member can dial-up the Network via a wireless PDA or other wireless device to log-in to the Network (see FIG. 4). The member will then select from several “match” options (see FIG. 9). Options may include, but are not limited to:

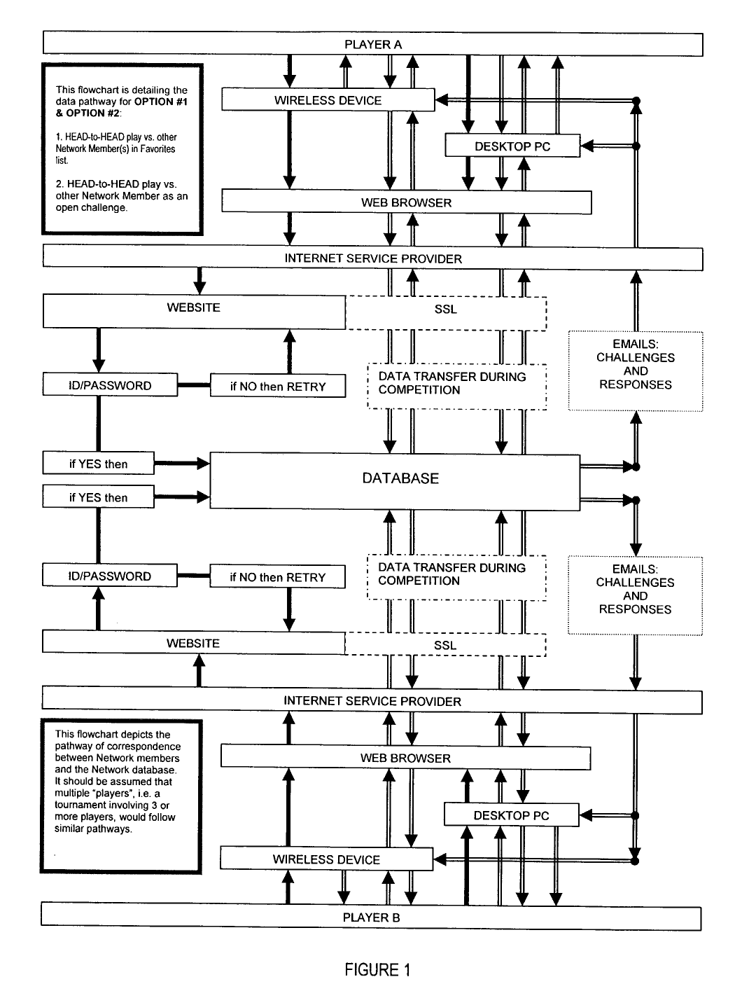

Option 1: HEAD-to-HEAD play vs. other Network member(s) in Favorites list (see FIG. 1)

The Member can select from his/her Favorites list, in advance of the desired tee time, and enter a challenge to prearrange a match. The Network will contact all challenge recipients and coordinate response affirmations for the challenge and instruct the participants on the appropriate time frame in order for each participant to secure reservations on their golf course within the time frame.

Just prior to the member's actual tee times, each participating member will log-in to the Network via wireless device to be entered into the match (matches will correlate within a pre-determined time window, due to the fact that not all golf courses set tee times alike). If three or more members are involved in one particular match, the odds of securing an individual “WIN” for the round are increased, thus heightening the sense of competition and performance.

Option 2: HEAD-to-HEAD play vs. other Network Member as an Open Challenge (see FIG. 1)

This option links two members unknown to each other in a head-to-head experience. It is an exciting alternative because the open challenge notion brings with it the element of the unknown competitor.

Just prior to the member's actual tee time, the member will log-in to the Network in order to enter a Network-wide open challenge. The Network will search for another open challenge within a certain timeframe (matches will correlate within a pre-determined time window, due to the fact that not all golf courses set tee times alike). The Network will assign and coordinate a head-to-head match between such two open challenges.

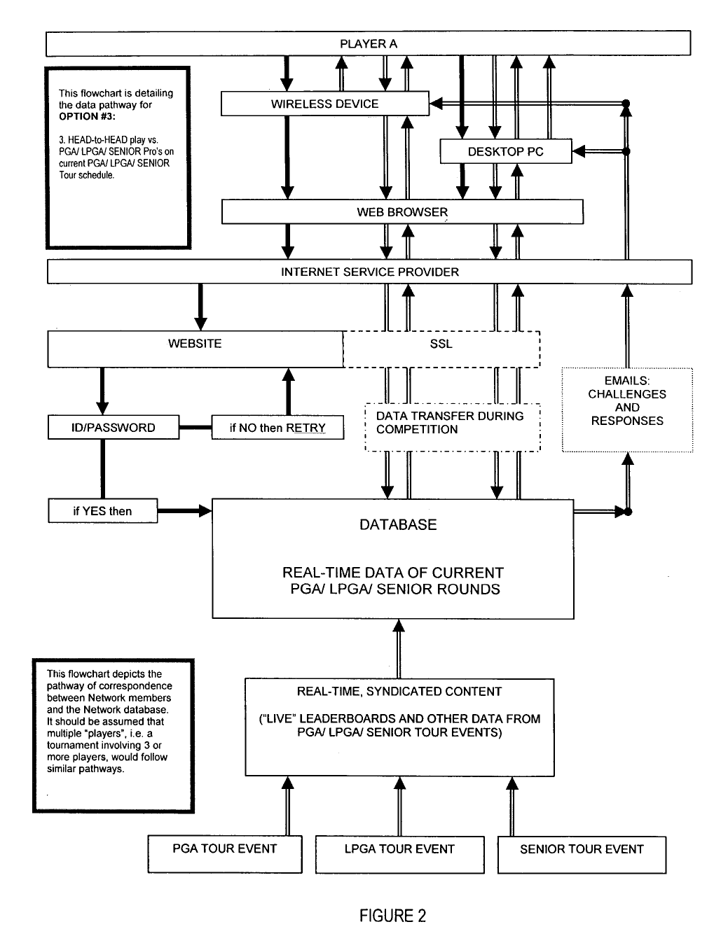

Option 3: HEAD-to-HEAD play vs. PGA/LPGA/SENIOR Pro on Current Tour Schedule (see FIG. 2)

This option is also an exciting alternative because the member can choose to simulate the same experience, but take it to a higher level by being matched up with an actual professional's round that falls within the same time frame.

Just prior to the member's actual tee time, the member will log-in to the Network in order to enter a challenge versus a PGA/LPGA/SENIOR pro in real-time. The Network will search a list of live pro rounds within a pre-determined time window. The Network will assign and coordinate a head-to-head match between the member and the chosen professional.

An exciting example of this feature would that a member could time his/her round to correlate with Tiger Woods or any other popular professional on the final day of a major championship event.

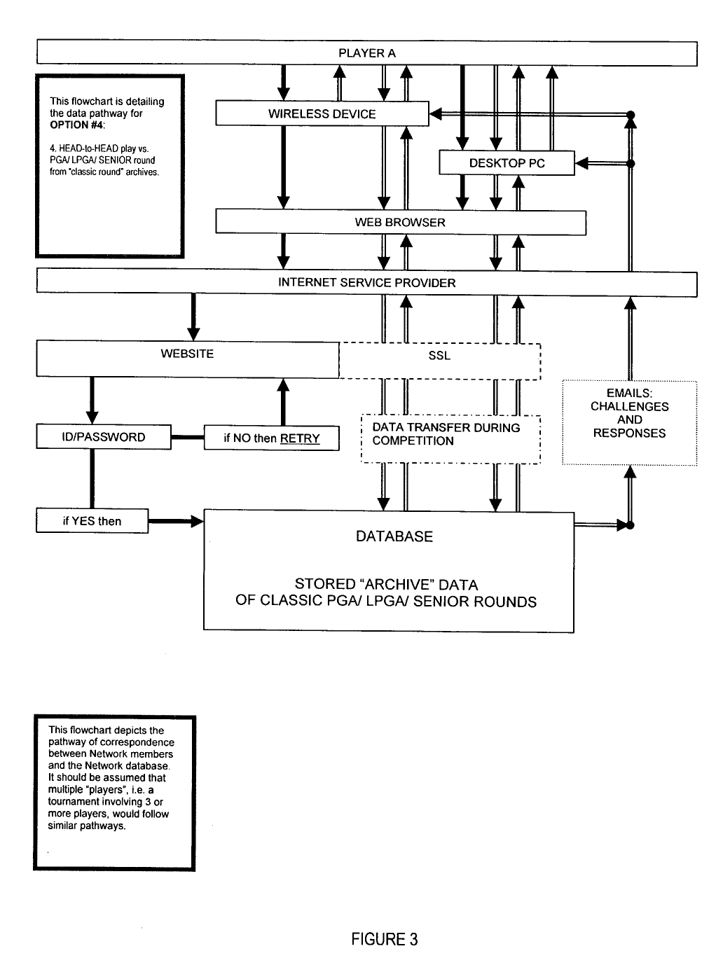

Option 4: HEAD-to-HEAD Play vs. PGA/LPGA/SENIOR Pro from “Classic Round” Archives (see FIG. 3)

This option allows an interesting alternative for the more nostalgic member to simulate the same experience, but take it to a different level by being matched up with an actual PGA/LPGA/SENIOR pro round from an archive of “classic rounds”, i.e. Tiger Woods' 1998 record-breaking Master's Championship final round at Augusta National, or Jack Nicklaus' 1971 U.S. Open Championship final round at Pebble Beach, which featured his famous 1-iron tee shot on the par 3, 17^{th} Hole.

Just prior to the member's actual tee time, the member will log-in to the Network in order to enter a challenge versus an actual PGA/LPGA/SENIOR pro round from an archive of “classic rounds”. The Network will list a selection of stored “classic rounds” for the member's selection, and the Network will assign and coordinate a head-to-head match between the member and the chosen “classic round”.

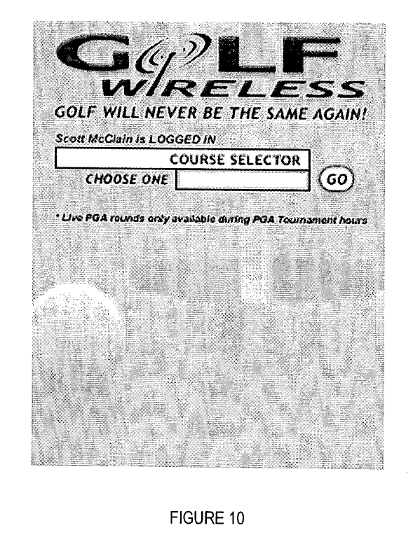

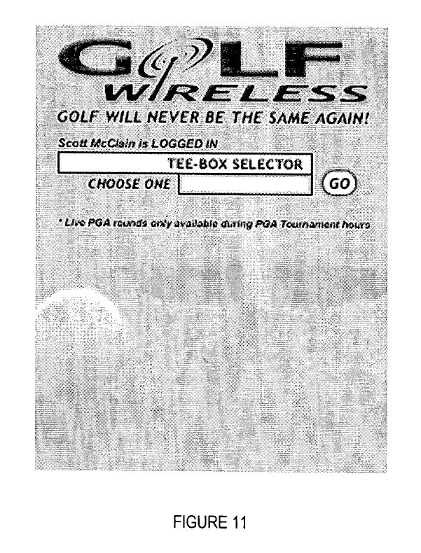

Once the member has established the type of match for the current round, the member will then be prompted to enter the course name and location for his/her current round (see FIG. 10). Once the course is selected, the member will be prompted to select the set of tees they will be using on the current course for the current round (see FIG. 11).

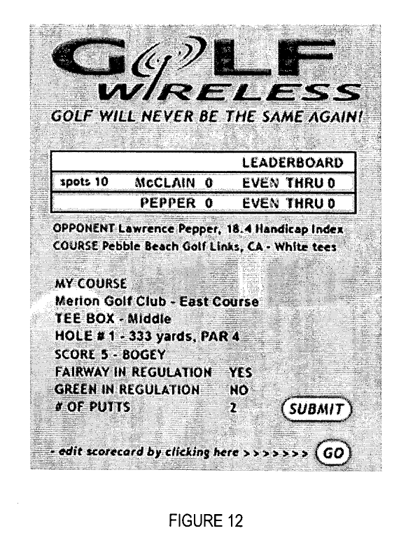

The Network will let all members in the match know the identity of the opponent(s), including name, golf course name and location, Handicap Index and the adjusted stroke spotting for the current match (see FIG. 12).

The Network will contain a wagering module as an option for those members desiring to wager with other Network members on any given match in which they are participating. In order for the wagering module to be effective in any given match, all members participating in the match must have the module active, as well as have an active pre-established wagering account with available funds in place.

From the Members Only section of the Network, each member will be able to establish a wagering account to hold monetary funds. This account can be tied to a credit card number or bank account for convenient, online transfer of funds. This section of the Network will be securely treated for the highest possible privacy protection and security of unique member identities, personal information and funds.

Preset monetary fund levels can be designated for member alerts via email or wireless device to notify the member that they need to deposit additional funds. A statistical accrual of wagering performance will be tracked and can be viewed through the Members Only section of the Network. This will have multiple charts and graphs, depending on the members' preferences, and will also be available for viewing.

Prior to the current round, players will be able to send inquiry messages pertaining to any wagering for the current round, and the acceptable wagering terms and conditions can be established.

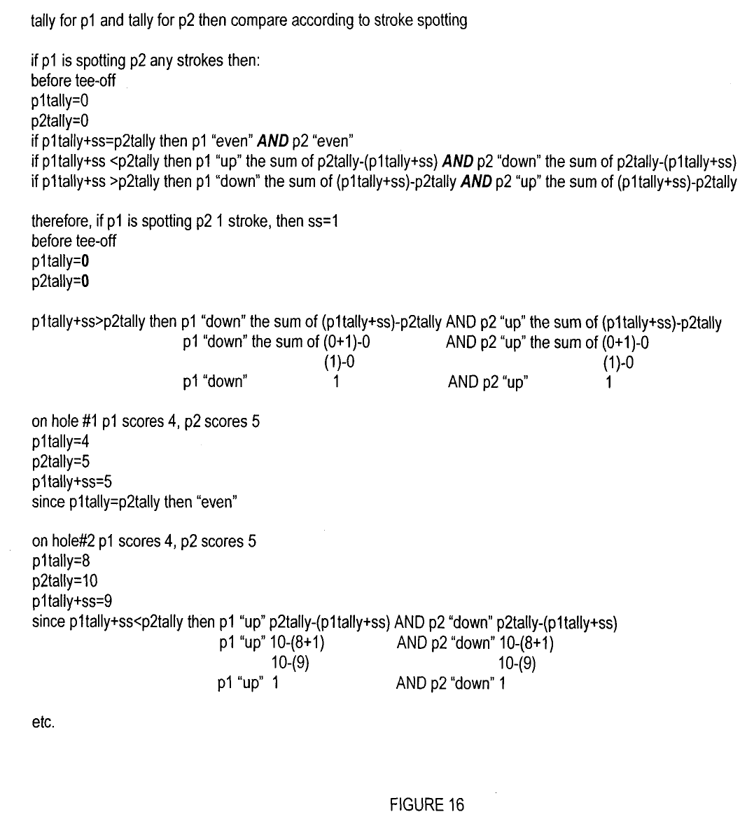

As the members play their respective, actual golf rounds, in real-time, they will be entering their own strokes (and other golf round information) on each hole and sending the updated score to the Network via wireless device, in real-time (see FIG. 12). As play continues, the Network will calculate a real-time score adjustment based upon the running tally of each player, and the aforementioned stroke-spotting calculations (see FIG. 16).

An ongoing “leader board” style response from the Network will keep members updated in real-time as to their respective positions in the match, thus simulating an actual tournament experience (see FIG. 12). Other golf round metrics, such as fairways in regulation, greens in regulation, putts-per-hole, etc. will be tracked and included in separate statistical categories (see FIG. 12).

At the conclusion of the match, each participant will see a win-tie-loss status for the match, as well as any additional metrics preferred by the member (i.e. “Today's round: WIN, fairways-in-regulation:75%, greens-in-regulation :63%, putts-per-hole:1.85”).

Also available for view will be the Member's cumulative records and metrics (i.e. “Win-Loss-Tie record to date:30-1-5, fairways-in-regulation to date:58%, greens-in-regulation to date:48%, putts-per-hole to date:2.3”).

Upon conclusion of the match, each competitor will have the option to send a message of good sportsmanship the corresponding opponent.

The Network will run an on-going, season-long tournament that will consist of the statistical accrual of every member match, and track related metrics of every member during the tournament's time frame. This tournament will be called the “Virtual Tournament”; inclusion of each round into the Virtual Tournament will be optional for Network members. (If a member chooses to exclude their match from the Virtual Tournament, it will have no effect on the functionality of the leader board for that match, or their overall, statistical accrual. It will only have an effect on their statistical accrual as it pertains to the Virtual Tournament.)

At the conclusion of the Virtual Tournament season, top winners in each category can be awarded tournament winnings or prizes. Categories can include, but are not limited to:

WIN-LOSS-TIE Record

Driving Accuracy (Fairways in Regulation)

Approach Accuracy (Greens in Regulation)

Putting Accuracy (Putts per Hole)

One potential embodiment of winnings or prizes can include a network sponsored, all-expenses-paid opportunity to play in an actual pro-am tournament, with actual PGA/LPGA/SENIOR professionals, through relationships between the network and the respective Professional Golf Associations.

An additional embodiment can include real-time television network broadcasting, wherein as players are playing in real-time versus PGA/LPGA/SENIOR professionals, the live, real-time postings of such matches can be incorporated into television network broadcasts through strategic relationships with the various Professional Golf Associations and their tournament broadcasters. This will be a highly useful marketing tool for additional member recruitment.

An additional embodiment can include stand-alone, time-specific events or tournaments, wherein the Network manages real-time, Network-wide tournaments for a plurality of Network members playing actual/physical rounds of golf on a plurality of golf courses. An example of this embodiment would be a Network-wide “holiday outing”, coordinated within a specific time frame, possibly “shot-gun start” style, open to Network members who desire to participate in real-time competition with a large plurality of other golfers; thus the competition is increased to a larger number of participants and further heightens the competitive experience.

Other embodiments and uses of the invention will be apparent to those skilled in the art from consideration of the specification and practice of the invention disclosed herein.

What is claimed is:

1. A method and a system for a real-time, worldwide, wireless, golf competition Network in which a plurality of remotely located players, of varying abilities, compete in real-time on an equitable basis while participating in head-to-head matches, and/or in a running tournament, in real-time, while playing actual/physical rounds of golf, in real-time, on separate golf courses, and while communicating in real-time through wireless devices connected to a central Network which manages the matches and/or the running tournament; the method comprising the steps of:
(a) creating unique identifications of individual golfers, to be stored in a central database within the Network, via a wireless device or personal computer;
(b) uniquely identifying a golfer communicating with the central database within the Network, in real-time;
(c) responding to a pre-established, paid account of the golfer for access to the Network, in order to participate in a match and/or tournament occurring within a fixed time window via a wireless device, in real-time;
(d) responding to stored identification information of unique golfers and corresponding golf course data, within the Network, within said fixed time window, in real-time, in order to establish stroke spotting;
(e) accessing the central database within the Network to store golfer information, and receiving from the central database within the Network assigned competitor information, that is generated as the golfer(s) participate in a head-to-head match and/or tournament vs. selected golfer(s) round(s) from a “Favorites” list, in real-time, via a wireless device;
(f) accessing the central database within the Network to store golfer information, and receiving from the central database within the Network assigned competitor information, that is generated as the golfer(s) participate in a head-to-head match and/or tournament vs. fellow “Network member” round(s), in real-time, via a wireless device;
(g) accessing the central database within the Network to store golfer information, and receiving from the central database within the Network assigned competitor information, that is generated as the golfer(s) participate in a head-to-head match and/or tournament vs. live, time-corresponding PGA/LPGA/SENIOR Professional Tour Member round(s), in real-time, via a wireless device;
(h) accessing the central database within the Network to store golfer information, and receiving from the central database within the Network assigned competitor information, that is generated as the golfer(s) participate in a head-to-head match and/or tournament vs. selected “classic/archived” PGA/LPGA/SENIOR Professional Tour Member round(s), in real-time, via a wireless device;
(i) tracking each golfer(s) performance levels in order to create an internal, Network Handicap Index for each member to be used only in Network-specific recreational events and related purposes, solely within the Network;
(j) tracking each golfer(s) performance levels in a running “Virtual Tournament” for future assessment and comparison network-wide in order to establish Network-wide rankings and award prizes;
(k) tracking an additional variety of performance metrics of golfers within the Network, in real-time;
(l) gathering demographical information of golfers within the Network for marketing purposes;
(m) managing wagers between golfers within the Network, in real-time;
(n) managing communications between golfers within the Network, in real-time;
(o) establishing a platform for secure corporate events between “branch offices” or other entities, in real-time; and
(p) managing certain Network-wide tournaments, in real-time.

2. The method of claim 1 wherein the system includes a Web-based Internet/lntranet/Extranet/LAN/WAN portal and/or other private wireless Network, as well as a centrally located database and/or databases, proprietary software coding, proprietary formula(s), certain related golf course data and golf related formula(s) within the Network.

3. The method of claim 1 wherein golfers create unique identifications to establish paid accounts, where golfer demographical information is gathered by the Network in the centrally located database and/or databases within the Network, for both match related purposes or for additional marketing purposes, via wireless device and or personal computer, these unique identifications including:
a. personal biographical information;
b. personal billing information;
c. personal golf related information; and
d. individual wagering accounts for each Network member in order to apply wagers to certain matches between Network members.

4. The method of claim 1 wherein golfers access the Network, via a wireless device, including:
a. golfers select a real-time match option including:
i. head-to-head versus “Favorites” list Network members
ii. head-to-head versus “open challenge” Network members
iii. head-to-head versus live PGA/LPGA/SENIOR professionals
iv. head-to-head versus archived rounds of PGA/LPGA/SENIOR professionals; and
b. golfers input the golf course data listing the golf course and tee-box from which they are playing.

5. The method of claim 1 wherein the Network responds to a pre-established, paid account of said players for access to the Network, in order to participate in a match and/or tournament occurring within a fixed time frame, in real-time, via a wireless device.

6. The method of claim 1 wherein the Network, upon receipt of information from various golfers within said fixed time frame arranges corresponding competitive matches based upon player preferences for match selections; player preferences including wherein the Network manages any corresponding wagers between Network members.

7. The method of claim 1 wherein:
a. the skill level of one golfer relative to another golfer is taken into account;
b. the difficulty of one golf course relative to another golf course is taken into account; and
c. the stroke adjustment of one individual golfer's skill level comparative to the golf course difficulty for said individual's present round, relative to the stroke adjustment of another individual golfer's skill level comparative to the golf course difficulty for said individual's present round is taken into account (one method of adjusting scores for the invention uses the USGA Handicap Index, Slope Rating system and Course Rating system to equitably compare the scores of rounds).

8. The method of claim 1 wherein the Network responds to stored identification information of unique golfers and corresponding golf course data within said fixed time frame, in real-time, in order to establish adjusted score stroke spotting.

9. The method of claim 1 wherein the Network, upon establishment of adjusted score stroke spotting, communicates to all players involved in such corresponding round, the appropriate adjusted score stroke spotting between players for the current round, in real-time.

10. The method of claim 1 further comprising the step wherein the input of scores for each hole by golfers is stored to the Network, in real-time, via a wireless device.

11. The method of claim 1 wherein a real-time posting of running score tallies for each hole are communicated or distributed by the Network to golfers; and a real-time posting of adjusted scores for each hole based upon stroke-spotting and upon the holes thus played, reflected in common golf terms of “up”, “down” or “even”, i.e. “up 1”, “down 1” or “even”, are communicated or distributed by the Network to golfers, in real-time, via a wireless device.

12. The method of claim 1 wherein the system will incorporate an internal, Network Handicap Index for each member that is to be used only for Network-specific recreational events and related purposes, solely within the Network. (This Network Handicap Index is not officially sanctioned by either the USGA or the Royal and Ancient Golf Club of St. Andrews, and will not be considered substitutable as, corresponding with, working in tandem with, working in conjunction with, replacements of, or replacements for an individual golfer's official USGA Handicap Index, unless otherwise noted. Official USGA Handicap Indexing should be handled only through the membership of an official USGA Golf Club or USGA Golf Association).

13. The method of claim 1 further comprising the step wherein a “virtual tournament” is managed, including:
a. individual golfer performance levels of win-loss-tie are tracked throughout a pre-determined amount of time, or golf “season” in a running “virtual tournament” both for personal golfer enrichment and in order to establish Network-wide rankings and award prizes;
b. additional individual golfer performance metrics such as fairways in regulation, greens in regulation, putts per hole, etc. are tracked throughout a pre-determined amount of time, or golf “season” in a running “virtual tournament” both for personal golfer enrichment and in order to establish Network-wide rankings and award prizes.
b. performance leaders are notified by the Network at the conclusion of a “virtual tournament” that they have “made the cut”;
c. the Network will pre-arrange matches with the corresponding performance leaders over a separate, pre-determined time period, in bracket fashion, in order to eliminate a pre-determined number of remaining golfers;
d. remaining winners of the aforementioned, bracket-fashion, pre-arranged matches are notified by the Network that they have again “made the cut”; and
e. Network-wide rankings are determined and communicated by the Network, and prizes are awarded.

14. The method of claim 1 wherein the communication of messages between golfers, including inquiry messages and acceptance or rejection messages to opponents pertaining to any wagers that might be applied to the corresponding matches, can be distributed through the management of the Network, in real-time.

15. The platform of claim 1 wherein secure, private corporate events are pre-determined and managed by the Network utilizing the same system applicable to individual golfers and/or matches, in real-time.

16. The method of claim 1 wherein the Network manages real-time, stand-alone, time-specific, Network-wide events or tournaments for a plurality of Network members playing actual/physical rounds of golf on a plurality of golf courses.
